(19) United States
(12) Patent Application Publication
(10) Pub. No.: US 2009/0164523 A1
(43) Pub. Date: Jun. 25, 2009

(54) SYSTEM AND METHOD FOR SENDING MESSAGES

(75) Inventors: CHUNG-I LEE, Tu-Cheng (TW); HAI-HONG LIN, Shenzhen City (CN); YUE-HAI YI, Shenzhen City (CN); YAO-HUEI SIE, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY(ShenZhen) CO., LTD, Shenzhen City (CN); HON HAI PRECISION INDUSTRY CO., LTD., Tu-Cheng (TW)

(21) Appl. No.: 12/337,636

(22) Filed: Dec. 18, 2008

(30) Foreign Application Priority Data
Dec. 21, 2007 (CN) 200710203323.0

(51) Int. Cl. G06F 17/00

(52) U.S. Cl. 707/104.1; 707/E17.005; 707/E17.045

(57) ABSTRACT

A computer-based method for sending messages is provided. The method comprises receiving one or more messages to be sent and predetermined parameters for sending the one or more messages, and saving the messages that have predetermined the sending time into a postponing table of a database. The method further comprises transferring the messages in the postponing table to a delivering table of the database in response to the determination that a current time reaches the sending time, and reading a message from the delivering table to send the message. Furthermore, the method comprises backing up the message into a backup table and deleting the message from the delivering table in response to the determination that the message has been sent successfully.

### BACKGROUND OF THE INVENTION

1. Field of the Invention

Embodiments of the present disclosure relate to information management systems and methods, and more particularly to a system and method for sending messages.

2. Description of Related Art

Messages can be used for communication between clients and a message sending server. The message sending server may send messages through electronic mail, or through the use of short messages, for example. However, in an enterprise, due to large numbers of messages need to be distributed, the message sending server may send some messages repeatedly or unsuccessfully. The clients may receive the emails or the short messages again and again, or may not receive the emails at all. As a result, work efficiency is decreased.

Therefore, what is needed is a system and method for sending messages, which can avoid sending the messages repeatedly and unsuccessfully.

### BRIEF DESCRIPTION OF THE DRAWINGS

FIG. 1 is a block diagram of one embodiment of a system for sending messages;

FIG. 2 is a block diagram of one embodiment of an application server of FIG. 1; and

FIG. 3 is a flowchart of one embodiment of a method for sending messages.

### DETAILED DESCRIPTION OF CERTAIN INVENTIVE EMBODIMENTS

All of the processes described below may be embodied in, and fully automated via, function code modules executed by one or more general purpose computers or processors. The code modules may be stored in any type of computer-readable medium or other computer storage device. Some or all of the methods may alternatively be embodied in specialized computer hardware.

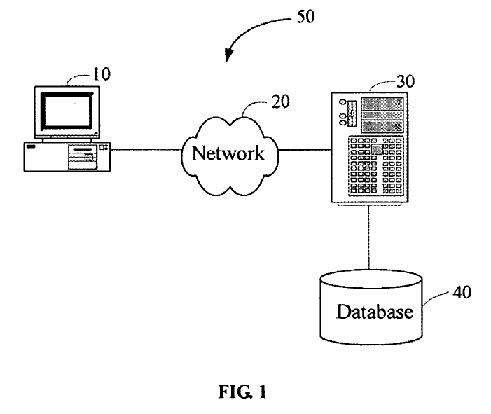

FIG. 1 is a block diagram of one embodiment of a system 50 for sending messages. In the illustrated embodiment, the system 50 comprises an application server 30, a database 40 connected to the application server 30, and one or more client computers 10 (only one shown). The one or more client computers communicate with the application server 30 via a network 20. Depending on the embodiment, the application server 30 may be a personal computer (PC), a network server, or other appropriate data-processing equipment. Each of the one or more client computers 10 provides an operation interface for controlling one or more operations of the application server 30. The network 20 may be a wide area network (i.e., the Internet) or a local area network.

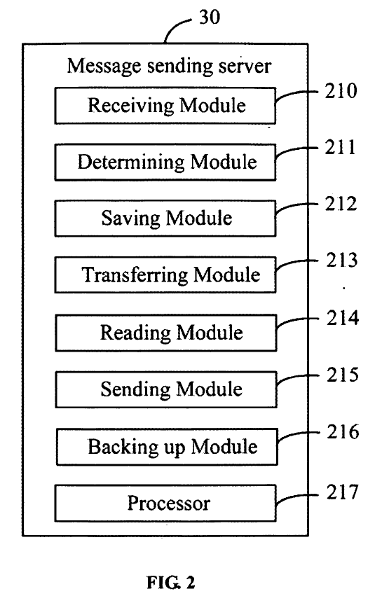

FIG. 2 is a block diagram of one embodiment of the application server 30 of FIG. 1. The application server 30 includes a receiving module 210, a determining module 211, a saving module 212, a transferring module 213, a reading module 214, a sending module 215, and a backing up module 216. The modules 210, 211, 212, 213, 214, 215, 216 may be used to execute one or more operations for the application server 30. Additionally, the application server 1 may comprise one or more specialized or general purpose processors, such as a processor 217, for executing the modules 210, 211, 212, 213, 214, 215, 216.

The receiving module 210 is configured for receiving one or more messages to be sent and predetermined parameters for sending the one or more messages. The predetermined parameters comprise addressee information of the one or more messages. In one embodiment, the messages and the predetermined parameters are set through the client computer 10. The addressee information comprises a name, an e-mail address and a telephone number of the addressee. Each of the one or more messages comprises a title, content, and a name of an addresser. In addition, the predetermined parameters may further comprise predetermine a sending time of the one or more messages.

The determining module 211 is configured for determining if the predetermined parameters comprise a sending time. In one embodiment, a user may predetermine a sending time for sending the one or more messages.

The saving module 212 is configured for saving the one or more messages into a postponing table of a database 40, or saving the one or more message into a delivering table of the database 40. In one embodiment, the postponing table stores the messages that have predetermined the sending times. The delivering table stores the messages to be sent promptly.

The determining module 211 is further configured for determining if a current time reaches the sending time of any messages to be sent. In one embodiment, for example, if a certain message is set to be sent at 9:00 A.M., the determining module 210 detects if the current time reaches at 9:00 A.M.

The transferring module 213 is configured for transferring the one or more messages from the postponing table to the delivering table if the current time reaches the sending time of the one or more messages.

The reading module 214 is configured for reading the one or more messages from the delivering table one by one.

The sending module 215 is configured for sending the read message in the delivering table to an addressee according to the addressee information and generating a result tag. The determining module 211 determines if the message has been sent to the addressee successfully according to the result tag. The sending module 215 resends the message to the addressee if the message has not been sent to the addressee successfully.

The backing up module 216 is configured for backing up the message into a backup table and deleting the message that has been sent successfully from the delivering table.

The determining module 211 is further configured for determining if the delivering table contains any other messages to be sent.

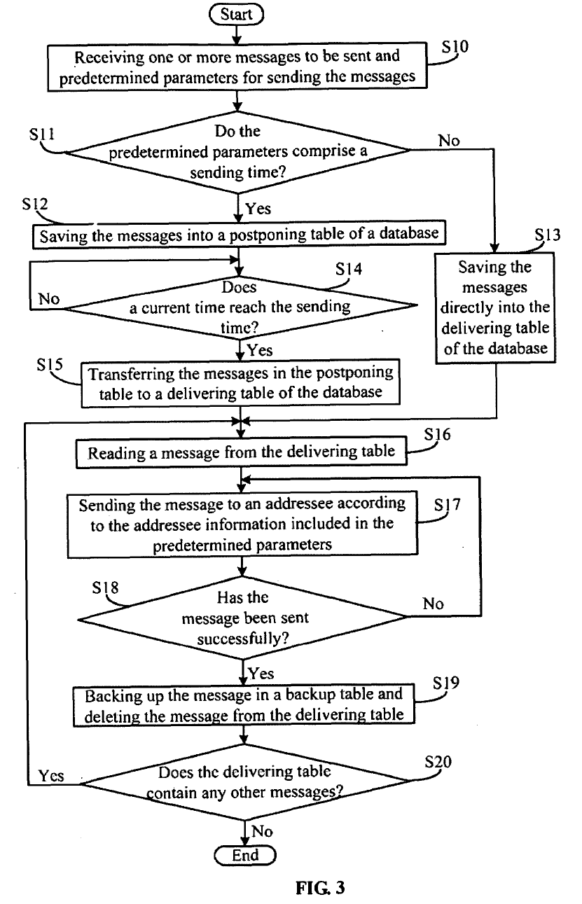

FIG. 3 is a flowchart of one embodiment of a method for sending messages. Depending on the embodiment, additional blocks may be added, others deleted, and the ordering of the blocks may be changed.

In block S10, the receiving module 210 receives one or more messages to be sent and predetermined parameters for sending the one or more messages from the client computer 10. The predetermined parameters comprise addressee information of the one or more messages. As mentioned above, the addressee information comprises a name, an e-mail address and a telephone number of the addressee. Each of the one or more messages comprises a title, content, and a name of an addresser. In addition, the predetermined parameters may further comprise predetermine a sending time of the one or more messages.

In block S11, the determining module 211 determines if the predetermined parameters comprise a sending time. As mentioned above, a user may predetermine the sending time of an message is 9:00 A.M.

In block S11, if the determining module 212 determines the predetermined parameters do not comprise a sending time, the procedure turns to block S13. Otherwise, if the determining module 212 determines the predetermined parameters comprise a sending time, the procedure turns to block S12.

In block S12, the saving module 212 saves the one or more messages that have a predetermined sending time into a postponing table of a database 40. For example, the saving module 212 saves the message scheduled to be send at 9:00 A.M. into the postponing table.

In block S13, the saving module 212 saves the one or more messages that have no predetermined sending time directly into a delivering table of a database 40, then the procedure turns to block S 16.

In block S14, the determining module 211 periodically determines if a current time reaches the predetermined sending time of any messages. As mentioned above, for example, the determining module 210 periodically determines if the current time reaches at 9:00 A.M.

In block S15, the transferring module 213 transfers the one or more message from the postponing table to the delivering table in response to the determination that the current time reaches the predetermined sending time. For example, if the current time reaches 9:00 A.M., the transferring module 213 transfers the message scheduled to be sent at 9:00 A.M. to the delivering table.

In block S16, the reading module 214 reads a message from the delivering table. For example, the reading module 214 reads a certain message scheduled to be sent at 9:00 A.M. from the delivering table.

In block S17, the sending module 215 sends the read message in the delivering table to an addressee according to the addressee information and generates a result tag. In one embodiment, the message may be sent through an e-mail or a short message. For example, the sending module 215 sends an e-mail contained the message to the addressee according to the e-mail address of the addressee, the e-mail comprises a title, content, and a name of an addresser. As mentioned above, the result tag is used for determining if the message has been sent to the addressee successfully.

In block S18, the determining module 211 determines if the message has been sent successfully according to the result tag. If the determining module 211 determines the message has not been sent successfully according to the result tag, the procedure returns to block S17. Otherwise, if the determining module 211 determines the message has been sent successfully according to the result tag, the procedure returns to block S19.

In block S19, the backing up module 216 backs up the message into a backup table of the database 40 and deletes the message in the delivering table. In one embodiment, the backup table stores all of the sent messages that have sent successfully, the backup table can help query information of the sent messages if needed.

In block S20, if the determining module 211 determines if the delivering table contains any other messages. If the determining module 211 determines the delivering table contains any other messages, the procedure returns to the block S16. Otherwise, if the determining module 211 determines the delivering table does not contain any other messages, the procedure ends.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for sending messages, the system comprising:
a receiving module configured for receiving one or more messages to be sent and predetermined parameters for sending the one or more messages, the predetermined parameters comprising addressee information of the one or more messages;
a determining module configured for determining if the predetermined parameters comprise a sending time;
a saving module configured for saving the one or more messages into a postponing table of a database in response to the determination that the predetermined parameters comprise a sending time, or saving the one or more messages into a delivering table of the database in response to the determination that the predetermined parameters do not comprise a sending time;
a transferring module configured for transferring the one or more messages from the postponing table to the delivering table in response to the determination that a current time of the one or more messages reaches the sending time;
a reading module configured for reading a message from the delivering table;
a sending module configured for sending the read message in the delivering table to an addressee according to the addressee information and generating a result tag;
the determining module further configured for determining if the message has been sent successfully according to the result tag;
a backing up module configured for backing up the message into a backup table and deleting the message from the delivering table in response to the determination that the message has been sent successfully; and
at least one processor for executing the receiving module, the determining module, the saving module, the transferring module, the reading module, the sending module and the backing up module.

2. The system of claim 1, wherein the addressee information comprises a name, an e-mail address and a telephone number of the addressee.

3. The system of claim 1, wherein the message is sent through an e-mail or through a short message.

4. The system of claim 3, wherein each of the one or more messages comprises a title, content, and a name of an addresser.

5. The system of claim 1, wherein the determining module is further configured for determining if the delivering table contains any other messages to be sent.

6. A computer-based method for sending messages, the method comprising:
(a) receiving one or more messages to be sent and predetermined parameters for sending the one or more messages, the predetermined parameters comprising addressee information of the one or more messages;
(b) saving the one or more messages into a postponing table of a database in response to the determination that the predetermined parameters comprise a sending time, and transferring the one or more messages from the postponing table to a delivering table of the database in response to the determination that the current time reaches the sending time; or
(c) saving the one or more messages into the delivering table of the database directly in response to the determination that the predetermined parameters do not comprise a sending time;
(d) reading a message from the delivering table;
(e) sending the read message in the delivering table to an addressee according to the addressee information, and generating a result tag;
(f) determining if the message has been sent successfully according to the result tag;
(g) backing up the message into a backup table and deleting the message from the delivering table in response to the determination that the message has been sent successfully, or returning to block (e) in response to the determination that the message has not been sent successfully; and
repeating the blocks (d)-(g) until the delivering table does not contain any other messages to be sent.

7. The method of claim 6, wherein the addressee information comprises a name, an e-mail address and a telephone number of the addressee.

8. The method of claim 6, wherein each of the one or more messages is sent through an e-mail or through a short message.

9. The method of claim 8, wherein each of the one or more messages comprises a title, content, and a name of an addresser.

10. A computer-readable medium having stored thereon instructions that, when executed by a computing device, causing the computing device to perform a method for sending messages, the method comprising:
(a) receiving one or more messages to be sent and predetermined parameters for sending the one or more messages, the predetermined parameters comprising addressee information of the one or more messages;
(b) saving the one or more messages into a postponing table of a database in response to the determination that the predetermined parameters comprise a sending time, and transferring the one or more messages from the postponing table to a delivering table of the database in response to the determination that the current time reaches the sending time; or
(c) saving the one or more messages into the delivering table of the database directly in response to the determination that the predetermined parameters do not comprise a sending time;
(d) reading a message from the delivering table;
(e) sending the read message in the delivering table to an addressee according to the addressee information, and generating a result tag;
(f) determining if the message has been sent successfully according to the result tag;
(g) backing up the message into a backup table and deleting the message from the delivering table in response to the determination that the message has been sent successfully, or returning to block (e) in response to the determination that the message has not been sent successfully; and
repeating the blocks (d)-(g) until the delivering table does not contain any other messages to be sent.

11. The medium of claim 11, wherein the addressee information comprises a name, an e-mail address and a telephone number of the addressee.

12. The medium of claim 11, wherein each of the one or more messages is sent through an e-mail or through a short message.

13. The medium of claim 12, wherein each of the one or more messages comprises a title, content, and a name of an addresser.
